(19) United States
(12) Patent Application Publication
(10) Pub. No.: US 2010/0332082 A1
(43) Pub. Date: Dec. 30, 2010

(54) METHOD AND APPARATUS FOR CONTROLLING STEERING FORCE

(75) Inventor: Seong-joo KIM, Seongnam-si (KR)

Correspondence Address: MCDERMOTT WILL & EMERY LLP, 600 13TH STREET, N.W., WASHINGTON, DC, 20005-3096, US

(73) Assignee: MANDO CORPORATION

(21) Appl. No.: 12/820,935

(22) Filed: Jun. 22, 2010

(30) Foreign Application Priority Data
Jun. 30, 2009 (KR) 10-2009-0059095

(51) Int. Cl. B62D 6/08

(52) U.S. Cl. 701/42

(57) ABSTRACT

Disclosed is a method and an apparatus for controlling steering force, by which every driver can feel a steering sense that the driver wants. In the method, a torque signal is compensated for by using a compensation value input by a driver, and the steering force is controlled using the compensated torque signal, so as to provide every driver with a satisfactory steering sense and a convenience in handling the steering wheel.

### BACKGROUND OF THE INVENTION

1. Field of the Invention

The present invention relates to a method and an apparatus for controlling steering force. In particular, the present invention relates to a method and an apparatus for controlling steering force, by which every driver can feel a steering sense that the driver wants.

2. Description of the Prior Art

Conventional power steering systems provide an assisting power, which changes according to the speed of a vehicle. That is, when the vehicle is driven at a low speed, the steering wheel is made to feel light so that the driver can easily steer the steering wheel. When the vehicle is driven at a high speed, the steering wheel is made to feel heavy so as to prevent too rapid operation of the steering wheel. As a result, the adaptively changing assisting power provided by the conventional power steering systems provides convenience in the operation of the steering wheel and improves the stability of the driving.

However, the steering sense provided to the drivers by the conventional power steering systems as described above may not satisfy the drivers since the steering forces desired by the drivers may be different according to the drivers. Therefore, there has been requirement for a steering force control technology, which the conventional power steering systems have not provided yet.

### SUMMARY OF THE INVENTION

Accordingly, the present invention has been made to solve the above-mentioned problems occurring in the prior art, and an object of the present invention is to provide a method and an apparatus for controlling steering force, by which every driver can feel a steering sense that the driver wants.

In order to accomplish this object, there is provided an apparatus for controlling a steering force, the apparatus including: a compensation value input unit for receiving a compensation value for the compensation of a torque signal through a driver interface; a torque signal input unit for receiving a torque signal from a torque sensor; a torque signal compensation unit for generating a compensation torque signal by compensating for the torque signal based on the compensation value; and a steering force control unit for controlling the steering force based on the compensation torque signal.

In accordance with another aspect of the present invention, there is provided a method of controlling a steering force, the method including: receiving a compensation value for the compensation of a torque signal through a driver interface; receiving a torque signal from a torque sensor; generating a compensation torque signal by compensating for the torque signal based on the compensation value; and controlling the steering force based on the compensation torque signal.

According to an embodiment of the present invention as described above, a torque signal is compensated for by using a compensation value input by a driver, and the steering force is controlled using the compensated torque signal, so as to provide each driver with a satisfactory steering sense and a convenience in handling the steering wheel.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a steering force control apparatus according to an embodiment of the present invention;

FIG. 2 is a flowchart of a method of providing a steering force according to an embodiment of the present invention; and

FIGS. 3A to 3G are graphs showing generated compensation torque signals and current change according to seven compensation values.

### DETAILED DESCRIPTION OF THE EXEMPLARY EMBODIMENTS

Hereinafter, exemplary embodiments of the present invention will be described with reference to the accompanying drawings. In the following description and drawings, the same reference numerals are used to designate the same or similar components, and so repetition of the description on the same or similar components will be omitted. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, assembled or joined to the second component.

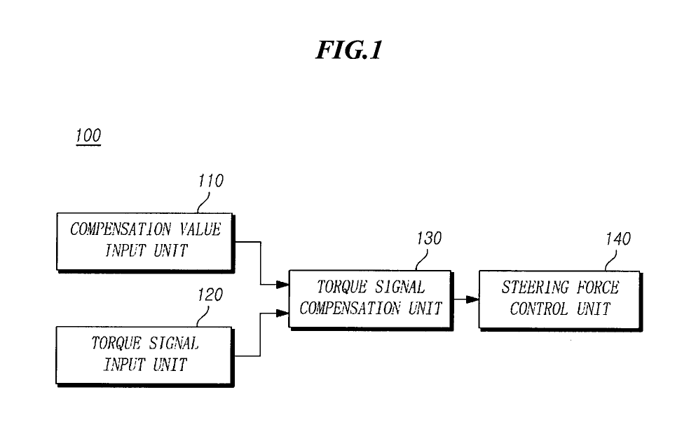

FIG. 1 is a block diagram of a steering force control apparatus 100 according to an embodiment of the present invention.

The steering force control apparatus 100 according to an embodiment of the present invention illustrated in FIG. 1 is a steering force controlling apparatus that compensates for a torque signal so that every driver can feel the steering sense that the driver wants.

Referring to FIG. 1, the steering force control apparatus 100 according to an embodiment of the present invention includes a compensation value input unit 110 for receiving a compensation value for the compensation of a torque signal through a driver interface (not shown), a torque signal input unit 120 for receiving a torque signal from a torque sensor, a torque signal compensation unit 130 for generating a compensation torque signal by compensating for the torque signal based on the input compensation value, and a steering force control unit 140 for controlling the steering force based on the generated compensation torque signal.

The compensation value input unit 110 receives a compensation value, which is a plus value or a minus value according to user's setting. The input compensation value may be based on, for example, the unit of percent (%). For example, when a driver feels like the steering wheel is too heavy for handling and wants to make the steering sense 10% lighter, a compensation value of −10% may be input as the value set by the user. In contrast, when a driver feels like the steering wheel is too light for handling, is afraid of too rapid steering, and wants to make the steering sense 15% heavier, a compensation value of +15% may be input as the value set by the user.

In the driver's setup for the input of the compensation value, a diagnosing apparatus may be used. The conventional user setup method that uses various information maps is problematic in that it requires a large memory for the various maps and it is difficult to perform tuning of the user setup for the input of a proper compensation value. However, the driver's setup by using a diagnosing apparatus as described above can overcome the problems of the conventional user setup method and enables the input of various compensation values with only one information map for user setup.

The torque signal compensation unit 130 generates a compensation torque signal by compensating for an input torque signal based on the input compensation value. As an example of such a compensation torque signal generation process, the torque signal compensation unit 130 may first acquire a variance torque signal by multiplying the torque signal input to the torque signal input unit 120 by the compensation value input to the compensation value input unit 110, and then generate a compensation torque signal by adding the torque signal input to the torque signal input unit 120 and the acquired variance torque signal. An example of the compensation torque signal can be obtained by Equation (1) below.

$$\begin{matrix}Compensation torque signal = torque signal ⋆ \\ ( 1 + compensation value / 100 ) \\ = torque signal + torque signal ⋆ \\ compensation value / 100 \\ = torque signal + variance torque signal\end{matrix} \qquad ( 1 )$$

In Equation (1), the compensation value is a percent value (%) having a plus sign or a minus sign. Therefore, the variance torque signal obtained by using the compensation value also has a plus sign or a minus sign.

The steering force control unit 140 as described above can perform a steering force control, which assists the steering force through controlling the magnitude of the assisting steering force, such that the maximum current supplied by the compensation torque signal generated by the torque signal compensation unit 130 becomes equal to the maximum current supplied by the torque signal input through the torque signal input unit 120.

For example, when the steering force control apparatus 100 according to an embodiment of the present invention is not used or the compensation value set by the user is 0%, it is assumed that the driver can input a torque of 50 kgf-cm and it is possible to supply the maximum current at this input torque.

On this assumption, let us consider a case in which the driver feels like the steering sense is too heavy and thus feels tired from driving. The steering force control apparatus 100 according to an embodiment of the present invention can lessen the overly heavy steering sense that the driver feels. When the driver inputs a value of −10% as a compensation value set in order to reduce the steering sense by 10%, the compensation value input unit 110 of the steering force control apparatus 100 receives the value of −10% as the compensation value, and the torque signal compensation unit 130 of the steering force control apparatus 100 compensates for the torque signal of 50 kgf-cm based on the compensation value of −10%, thereby generating a compensation torque signal of 45 kfg-cm (=50*(1+(−10/100)). The steering force control unit 140 performs a steering force control capable of supplying the maximum current from the generated compensation torque signal, so that the driver can feel a 10% lighter steering sense.

As another example, when the steering force control apparatus 100 according to an embodiment of the present invention is not used or the compensation value set by the user is 0%, it is assumed that the driver can input a torque of 50 kgf-cm and it is possible to supply the maximum current at this input torque.

On this assumption, let us consider a case in which the driver feels like the steering sense is too light and is afraid of unintended abrupt steering, which creates a sense of unease about driving. The steering force control apparatus 100 according to an embodiment of the present invention can add a sense of weight to the overly light steering sense that the driver feels. When the driver inputs a value of +5% as a compensation value set in order to add a sense of 5% more weight to the steering sense, the compensation value input unit 110 of the steering force control apparatus 100 receives the value of +5% as the compensation value, and the torque signal compensation unit 130 of the steering force control apparatus 100 compensates for the torque signal of 50 kgf-cm based on the compensation value of +5%, thereby generating a compensation torque signal of 52.5 kfg-cm (=50*(1+(5/100)). The steering force control unit 140 performs a steering force control capable of supplying the maximum current from the generated compensation torque signal, so that the driver can feel a 5% heavier steering sense.

As described above, the steering force control apparatus 100 according to an embodiment of the present invention compensates for a torque signal according to a compensation value input and set according to a driver's desire, and controls the steering force by using a compensation torque signal obtained through the compensation of the torque signal so that the driver can feel a desired steering force.

In the steering force control apparatus 100 according to an embodiment of the present invention as described above, since the compensation of the torque signal and the steering force control through the compensation are performed based on the compensation value set by the driver, a guarantee of control safety is required in setting the compensation value.

Therefore, examples of methods of setting a compensation value in view of a guaranteed control safety will be described hereinafter.

The examples of methods of setting a compensation value described below may include a method of setting a compensation value within a compensation value setup safety range and a method of selecting a compensation value from multiple stage compensation values pre-set according to the sense of weight of the steering wheel.

First, from among the examples of methods of setting a compensation value, the method of setting a compensation value within a compensation value setup safety range will be described hereinafter.

The compensation value input unit 110 receives a compensation value set by the driver through an interface (for example, a terminal within the vehicle, a setting button, etc.). Then, the compensation value input unit 110 determines if the input compensation value is within a compensation value setup safety range. Based on a result of the determination, the compensation value input unit 110 either compensates for or does not compensate for the torque signal.

As a result of the determination if the input compensation value is within a compensation value setup safety range, when the input compensation value is within a compensation value setup safety range, the compensation value input unit 110 transfers a command signal indicating that the compensation for the torque signal is possible or transmits the input compensation value to the torque signal compensation unit 130, so that the torque signal can be compensated for.

As a result of the determination if the input compensation value is within a compensation value setup safety range, when the input compensation value is not within a compensation value setup safety range, the compensation value input unit 110 transfers a command signal indicating that the compensation for the torque signal is impossible to the torque signal compensation unit 130 or prevents transmission of the input compensation value to the torque signal compensation unit 130, so that the torque signal is not compensated for.

Meanwhile, before receiving the compensation value, the compensation value input unit 110 may output information on a preset compensation value setup safety range through a driver interface to a voice output device or screen output device, so as to guide the setup of the compensation value. Then, the driver can identify the compensation value setup safety range for adjustment of the steering sense that the driver wants, and then set a desired compensation value of a plus or minus sign within the compensation value setup safety range through the driver interface.

Further, after receiving the compensation value, the compensation value input unit 110 may output compensation value resetting notification information for inducing the resetting of a compensation value through the driver interface to the voice output device or the screen output device, when the input compensation value is not within a compensation value setup safety range.

Next, from among the examples of methods of setting a compensation value, the method of selecting a compensation value from multiple stage compensation values pre-set according to the sense of weight of the steering wheel will be described hereinafter.

The compensation value input unit 110 notifies the driver of the multiple stage compensation values, which have been pre-set according to the sense of weight of the steering wheel and verified in advance based on the safety of the compensation value, by outputting the multiple stage compensation values through the driver interface. Then, the compensation value input unit 110 receives a compensation value selected by the driver from the multiple stage compensation values.

The steering force control apparatus 100 according to an embodiment of the present invention as described above may be implemented in an Electronic Control Unit (ECU), and may cooperate with a steering system or an assisting control unit for assisting the steering system or may be included in the steering system or the assisting control unit.

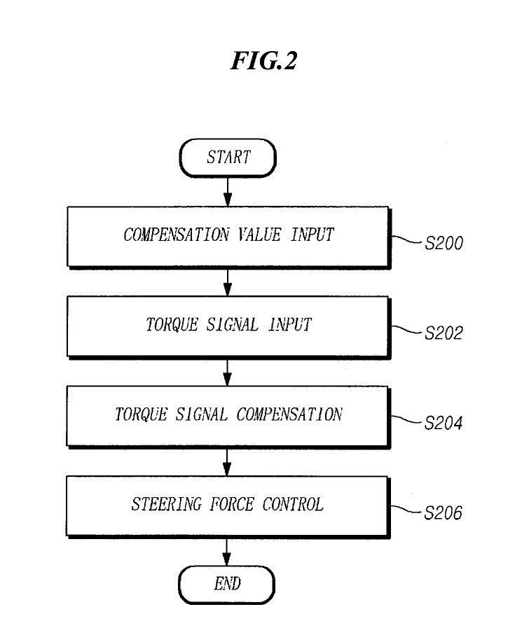

A method of providing a steering force by the steering force control apparatus 100 according to an embodiment of the present invention as described above with reference to FIG. 1 will be described below with reference to FIG. 2.

FIG. 2 is a flowchart of a method of providing a steering force according to an embodiment of the present invention.

Referring to FIG. 2, the method of providing a steering force according to an embodiment of the present invention includes: a compensation value input step (S200) of receiving an input of a compensation value; a torque signal input step (S202) of receiving an input of a torque signal from a torque sensor; a torque signal compensation step (S204) of compensating for the torque signal based on the compensation value, thereby generating a compensation torque signal; and a steering force control step (S206) of performing a steering force control based on the compensation torque signal.

The compensation value input step (S200) is a step in which a compensation value having a plus sign or minus sign according to user's setting is input. In step S200, the input compensation value may be based on the unit of, for example, percent (%). For example, when a driver feels like the steering wheel is too heavy for handling and wants to make the steering sense 10% lighter, a compensation value of −10% may be input through setting by the user. In contrast, when a driver feels like the steering wheel is too light for handling, is afraid of too rapid steering, and wants to make the steering sense 15% heavier, a compensation value of +15% may be input through setting by the user.

The torque signal compensation step (S204) is a step in which the input torque signal is compensated for based on the input compensation value, so as to generate a compensation torque signal. As an example of the generation of a compensation torque signal in step S204, a variance torque signal is first acquired by multiplying the torque signal input in the torque signal input step (S202) by the compensation value input in the compensation value input step (S200). Then, a compensation torque signal is generated by adding the torque signal input in the torque signal input step (S202) and the acquired variance torque signal. An example of the compensation torque signal can be obtained by Equation (1) described above.

The steering force control step (S206) is a step of assisting the steering force by generating a controlled assisting steering force such that the maximum current supplied by the compensation torque signal generated in the torque signal compensation step (S204) becomes equal to the maximum current supplied by the torque signal input in the torque signal input step (S202).

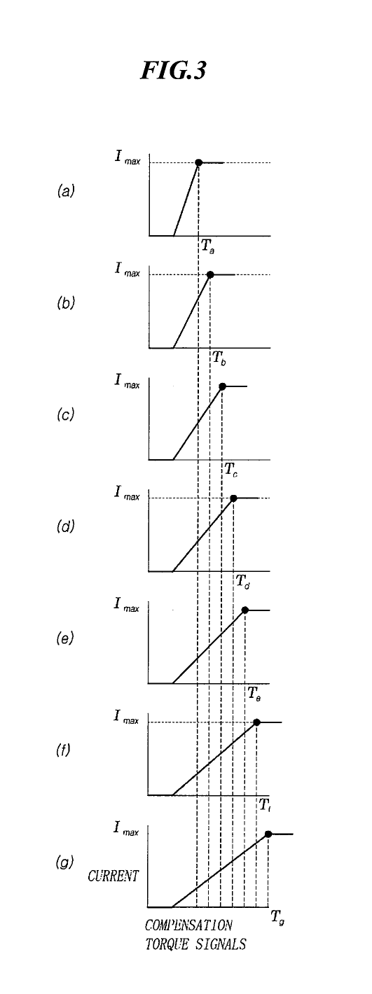

FIGS. 3A to 3G are graphs showing generated compensation torque signals and current change according to the signals when seven compensation values including −15%, −10%, −5%, 0, +5%, +10%, and +15% are input according to user's setting.

Referring to FIGS. 3A to 3G, which are graphs showing the relation between the compensation torque signals and the electric current, it is noted that the same maximum electric current Imax for the compensation values including −15%, −10%, −5%, 0, +5%, +10%, and +15% can be supplied at all of the compensation torque signal Ta, the compensation torque signal Tb, the compensation torque signal Tc, the compensation torque signal Td, the compensation torque signal Te, the compensation torque signal Tf, and the compensation torque signal Tg, respectively.

Referring to FIG. 3A, a compensation value of −15% is input, and the same maximum electric current Imax is supplied at the smallest compensation torque signal Ta from among the seven cases. Therefore, the driver may feel the lightest steering sense.

Referring to FIG. 3G, a compensation value of +15% is input, and the same maximum electric current Imax is supplied at the largest compensation torque signal Tg from among the seven cases. Therefore, the driver may feel the heaviest steering sense.

According to an embodiment of the present invention as described above, a torque signal is compensated for by using a compensation value input by a driver, and the steering force is controlled using the compensated torque signal, so as to provide every driver with a satisfactory steering sense and a convenience in handling the steering wheel.

Further, according to an embodiment of the present invention, a diagnosing apparatus may be used in the driver's setup for the input of the compensation value. In this case, the present invention enables the input of various compensation values with only one information map for user setup.

Even though it was described in the above that all of the components of an embodiment of the present invention are coupled as a single unit or coupled and operated as a single unit, the present invention is not limited to such an embodiment. That is, within the purpose of the present invention, all of the components may be selectively coupled and operated as one or more units. Further, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

In addition, since terms, such as “comprising,” “including,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are defined otherwise. A term ordinarily used like that defined by a dictionary shall be construed that it has a meaning equal to that in the context of a related description, and shall not be construed in an ideal or excessively formal meaning unless it is clearly defined in the present specification.

Although exemplary embodiments of the present invention have been described for illustrative purposes, those skilled in the art will appreciate that various modifications, additions and substitutions are possible, without departing from the scope and spirit of the invention as disclosed in the accompanying claims. Therefore, the embodiment disclosed in the present invention is intended to illustrate the scope of the technical idea of the present invention, and the scope of the present invention is not limited by the embodiment. The scope of the present invention shall be construed on the basis of the accompanying claims, and it shall be construed that all of the technical ideas included within the scope equivalent to the claims belong to the present invention.

What is claimed is:

1. An apparatus for controlling a steering force, the apparatus comprising:
a compensation value input unit for receiving a compensation value for compensation of a torque signal through a driver interface;
a torque signal input unit for receiving a torque signal from a torque sensor;
a torque signal compensation unit for generating a compensation torque signal by compensating for the torque signal based on the compensation value; and
a steering force control unit for controlling the steering force based on the compensation torque signal.

2. The apparatus of claim 1, wherein the compensation value input unit receives an input of the compensation value, which has a plus sign or a minus sign, according to user setting through the driver interface.

3. The apparatus of claim 1, wherein the compensation value input unit determines if the input compensation value is within a preset compensation value setup safety range, and performs a control of determining whether to compensate for the torque signal, based on a result of the determination.

4. The apparatus of claim 3, wherein:
when the input compensation value is within a compensation value setup safety range, the compensation value input unit transfers a command signal indicating that the compensation for the torque signal is possible or the input compensation value to the torque signal compensation unit, so that the torque signal is compensated for; and
when the input compensation value is not within a compensation value setup safety range, the compensation value input unit transfers a command signal indicating that the compensation for the torque signal is impossible to the torque signal compensation unit or prevents transmission of the input compensation value to the torque signal compensation unit, so that the torque signal is not compensated for.

5. The apparatus of claim 4, wherein:
before receiving the compensation value, the compensation value input unit outputs information on a preset compensation value setup safety range through the driver interface, so as to guide the setup of the compensation value; and
after receiving the compensation value, the compensation value input unit outputs compensation value resetting notification information through the driver interface, when the input compensation value is not within a compensation value setup safety range.

6. The apparatus of claim 1, wherein the compensation value input unit outputs multiple stage compensation values, which have been verified based on the safety of the compensation value and preset according to the sense of weight of the steering wheel, through the driver interface, and receives a compensation value selected from the multiple stage compensation values.

7. The apparatus of claim 1, wherein the torque signal compensation unit acquires a variance torque signal by multiplying the input torque signal by the compensation value, and then generates a compensation torque signal by adding the input torque signal and the acquired variance torque signal.

8. The apparatus of claim 1, wherein the steering force control unit performs a steering force control, which assists the steering force through control of a magnitude of an assisting steering force, such that a maximum current supplied by the compensation torque signal becomes equal to a maximum current supplied by the torque signal before the compensation.

9. A method of controlling a steering force, the method comprising:
receiving a compensation value for compensation of a torque signal through a driver interface;
receiving a torque signal from a torque sensor;
generating a compensation torque signal by compensating for the torque signal based on the compensation value; and
controlling the steering force based on the compensation torque signal.
